(19) United States
(12) Patent Application Publication
(10) Pub. No.: US 2003/0220881 A1
(43) Pub. Date: Nov. 27, 2003

(54) Electronic payments

(75) Inventors: Petri Pirhonen, Oulu (FI); Samuli Tuoriniemi, Oulu (FI); Virve Inget, Oulu (FI)

Correspondence Address: COHEN, PONTANI, LIEBERMAN & PAVANE, Suite 1210, 551 Fifth Avenue, New York, NY, 10176, US

(73) Assignee: Nokia Corporation

(21) Appl. No.: 10/338,557

(22) Filed: Jan. 8, 2003

(30) Foreign Application Priority Data
Jan. 23, 2002 (GB) 0201503.0

(51) Int. Cl. G06F 17/60

(52) U.S. Cl. 705/53

(57) ABSTRACT

There is disclosed a technique for secure mobile e-commerce transactions utilising mobile devices having DRM functionality, in which the payment of the transaction is guaranteed by a pre obtained credit.

### FIELD OF THE INVENTION

The present invention relates to mobile e-commerce using mobile devices, particularly in local or remote environments using a wireless link.

### BACKGROUND OF THE INVENTION

Techniques for mobile e-commerce are known and being developed. The present invention particularly relates to e-commerce transactions using a mobile device, such as a mobile telephone, in purchasing goods or services at a local terminal.

In such transactions, there is typically a wireless communication between the mobile devices and, for example, a point-of-sale terminal in a store, or other type of retail device such as a vending machine or ticket machine. The mobile device and the point-of-sale terminal communicate to exchange relevant data to negotiate the purchase of goods or services; including the communication of the payment means from the mobile equipment to the point-of-sale terminal.

In such transactions, the payment information transferred from the mobile device to the point-of-sale terminal is authorised by a digital signature applied to the payment information. A typical transaction effectively provides a credit card payment to the point-of-sale terminal with a digital signature.

One problem with such digital signature-based credit card payments is that there is no real-time check for credit limits, to ensure the user has proper funds for payment.

A further problem with digital signature credit card payments is that of so-called ‘micro-payments’. ‘Micro-payments’ are payment of small denomination, which it is undesirable to pay by credit card. For example if a payment of 50 cents is made by credit card, the expenses of clearing the payment are high compared to the payment itself.

Embodiments of the present invention aim to address one or more of the above problems.

### SUMMARY OF THE INVENTION

In one aspect the present invention provides a method for facilitating payments in a digital rights management enabled mobile device, comprising providing the mobile device with a payment voucher having a value limit. This value limit may be a credit limit.

The voucher is preferably provided by any one of: a credit agency; a bank; or a service provider. The voucher is preferably provided to the mobile device via a remote link. The remote link may be a radio link. The remote link may be established by a telephone connection with the mobile device.

The method may further comprise transmitting a payment from the mobile device using the payment voucher. The payment may be transmitted responsive to a request for payment. Responsive to request for payment, a payment amount may be compared to the payment voucher amount remaining. The step of transmitting a payment may be enabled responsive to the payment amount being less than or equal to the payment voucher remaining. Responsive to the step of transmitting a payment, the amount of the payment voucher may be decreased by the payment amount.

The step of transmitting a payment may include a step of transmitting a digital signature.

The voucher may comprise an electronic cheque book.

The payment may be transmitted on a local or remote wireless link. The local wireless link may be a short-range RF-link such as Bluetooth, or an infra-red link. The remote wireless link may for example be a GSM or GPRS link.

In a further aspect the present invention provides a digital rights management enabled mobile device comprising means for receiving a payment voucher having a value limit for use in payments.

The means for receiving the payment voucher may include a radio receiver. The radio receiver may be for receiving mobile telephone calls. The mobile device may further comprise means for transmitting a payment using the payment voucher. The means for transmitting may comprise a local or remote transmitter. The local transmitter may be a short-range RF-link such as Bluetooth, or an infra-red transmitter.

The means for transmitting a payment may be enabled by the digital rights management engine. The digital rights management engine may be adapted to control the means for transmitting a payment responsive to receipt of a payment request.

There may further be provided receiver means for receiving the payment request. The means for receiving the payment request may be a local receiver.

The digital rights management engine may be adapted to compare a payment amount in the payment request with the payment voucher amount. The digital rights management engine may enable the means for transmitting a payment if the payment amount is less than or equal to the payment voucher amount.

Responsive to the transmission of a payment the digital rights management engine may reduce the amount of the payment voucher by the payment amount.

The mobile device may be a mobile telephone.

The payments may be digital signature based.

### BRIEF DESCRIPTION OF DRAWINGS

For better understanding of the present invention, and as to how the same may be carried into effect, reference will now be made by way of example to the accompanying drawings in which:

FIG. 1 illustrates a connection scenario between a user and a financial services provider;

FIG. 2 illustrates the main elements of a mobile device for implementing the present invention;

FIG. 3 illustrates a connection scenario between a user and point-of-sale terminal. and

FIG. 4 illustrates a flow chart at an exemplary embodiment.

### DESCRIPTION OF PREFERRED EMBODIMENTS OF THE INVENTION

The present invention is described hereinafter with reference to a particular set of embodiments. However the invention is not limited to such embodiments. The invention is particularly described by way of reference to a particular wireless mobile network arrangement.

A particular embodiment of the present invention is now described with reference to the flow diagram of FIG. 4. The flow diagram of FIG. 4 represents an exemplary embodiment, and as will be further described herein below modifications and refinements to the flow diagram of FIG. 4 are permitted by the present invention.

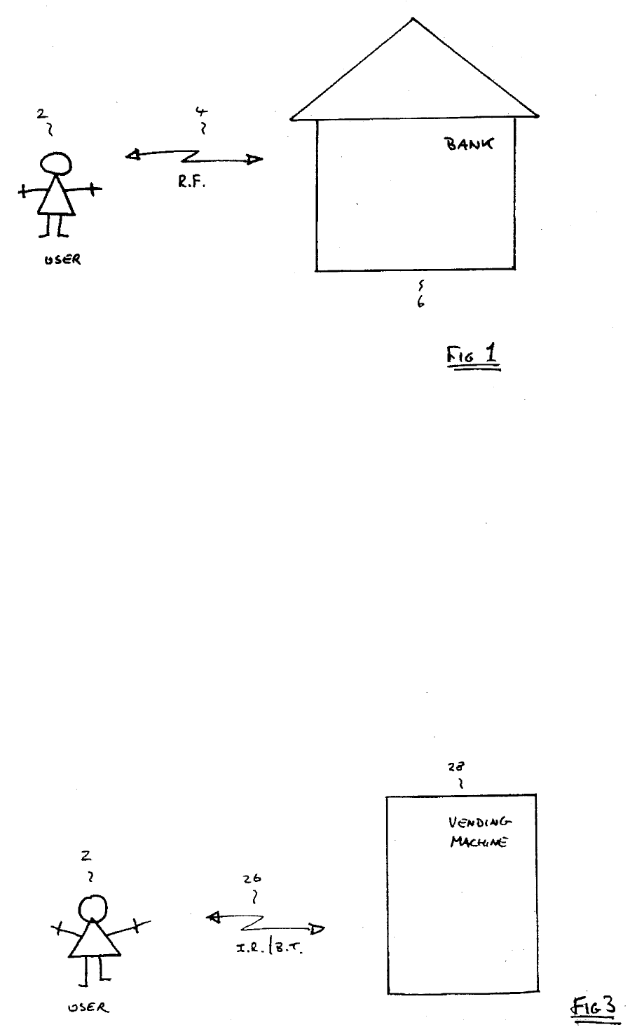

In a first step 50, a user downloads an electronic “voucher”. Referring to FIG. 1, a user 2 is associated with a mobile device. In the preferred embodiment the voucher is provided by a bank 6. However the voucher may be provided by another type of financial institution, such as a credit agency. Alternatively the voucher may be provided by any service provider. In the preferred embodiment the mobile device of the user 2 communicates with the bank 6 via a radio frequency (RF) link designated 4 in FIG. 1. Thus, in the preferred embodiment, the mobile device of the user establishes a mobile telephone connection to the bank in order to download the electronic voucher.

Such a mobile telephone connection may be established on a GSM wireless telephony system, such as CSD or GPRS. However the implementation of such a link is not important to the invention, and any mobile wireless technology may be adapted to support the link 4.

In addition, the RF link 4 need not be established by means of a telephone call. Whilst it is envisaged that the link will be established by a telephone call in preferred embodiments, the link may also be established by short range RF links, such as Bluetooth, or by other short range communication links such as infra-red.

In accordance with the present invention, the electronic voucher is associated with a fixed credit limit. The electronic voucher is preferably stored in a non-secure memory means of the mobile device. The term credit is intended to cover the situation where the voucher is a prepaid voucher or where the voucher provides a spending limit, similar to a credit card which cannot be exceeded.

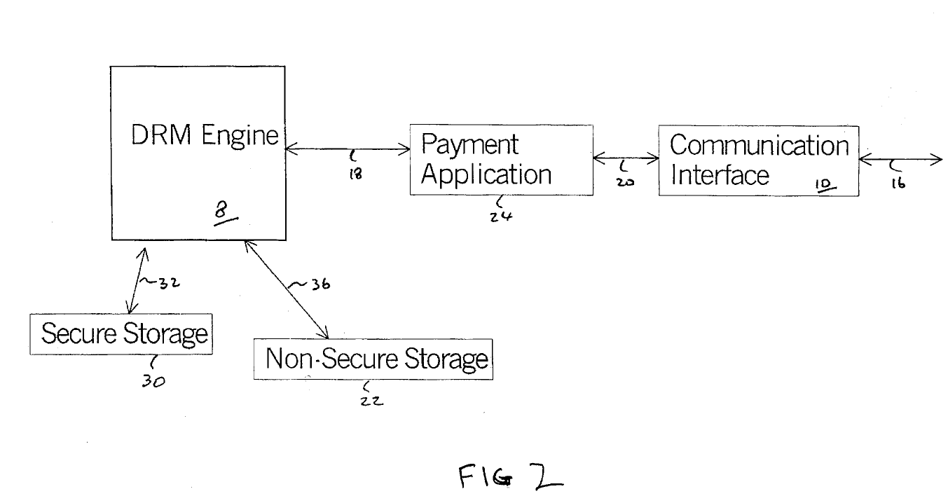

Referring to FIG. 2, there is illustrated in block diagram form the main functional elements of the mobile device required for implementing the present invention. The operation of a mobile device for e-commerce techniques will be familiar to one skilled in the art. Only such detail of the implementation of the mobile device is described herein as is necessary to understand the present invention.

Referring to FIG. 2, the mobile device includes a digital rights management (DRM) engine 8, a communication interface block 10, a payment application 24,, a secure memory or storage 30 and a non-secure memory or storage 22..

The DRM engine 8 is known in the art, and is provided for the purposes of controlling digital rights, for example the rights to digital music.. The voucher, as mentioned hereinabove, is stored in the non-secure memory 22 under the control of the DRM engine via communication link 36. As will be discussed further hereinbelow, the DRM engine controls the rights defined by a credit voucher, including updating the information about credit remaining on a voucher in the secure memory via communication link 32 The memory 30 is a secure memory area, which is only accessible to the DRM engine 8. It is not possible for a user of the user equipment to access the memory 30. The DRM engine may also be used for applying a digital signature to payments transmitted from the mobile device.

The DRM engine 8 receives and transmits signals to and from the communication interface block 10 via the payment application 24. The payment application 24 contains the payment logics of the mobile device.

In accordance with the present invention, the mobile deviceDRM engine 8 acts as a control block for the memories, i.e. the secure memory 30 and the non-secure memory 22.. The non-secure memory 22 is provided for the purposes of storing a downloaded voucher. The voucher store (non-secure memory) may be provided in any memory or storage device of the mobile device which is suitable for the purpose. The DRM engine 8 accesses the voucher store 22 using communication lines 36.

The payment application 24 receives via the communication interface 10 the downloaded voucher, and forwards it to the DRM engine 8 for storage in the non-secure memory 22. The secure memory is provided for the purposes of storing the remaining voucher value. The DRM engine 8 keeps track of the remaining value, and stores and updates it in the secure memory.

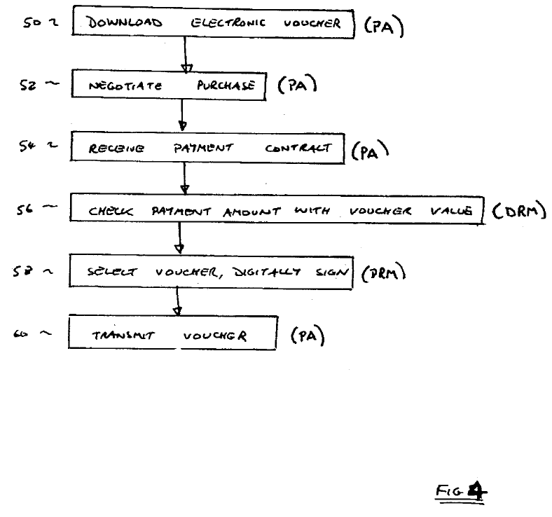

As will be further described herein below, the payment application 24 further receives a payment contract request from a point-of-sale terminal. The payment application 24 then sends a credit request to the DRM engine 8. The DRM engine returns credit information to the payment application, if the non-secure memory 30 indicates that credit is available. The DRM engine 8 then stores (or updates) the remaining credit in the secure memory 30. Once the voucher is downloaded and stored in the mobile device, then the credit associated with such voucher may be used by the user to purchase goods or services. Referring to FIG. 3, an example is shown where the user 2 purchases goods from a vending machine 28. In the preferred embodiment of the invention, such goods are purchased using the mobile device communicating with the vending machine 28 via an infra-red or Bluetooth link 26. However the nature of the link 26 is not important to the invention. Referring again to FIG. 4, in a step 52 the payment application 24 of the mobile device associated with the user 2 negotiates a purchase with the vending machine 28, which can more generally be considered to be a point-of-sale terminal. The negotiation of the purchase may include selecting goods.

Once the purchase is negotiated, in a step 54 the payment application 24 of the mobile device receives a payment contract from the point-of-sale terminal. The payment contract includes information associated with the transaction, including an identification of the payment and the payment amount.

The payment application communicates the payment amount to the DRM engine 8. Responsive thereto, the DRM engine 8 compares the payment amount with the credit remaining, stored in the secure memory 30 to determine whether the payment amount is less than or equal to the remaining value of the voucher. This operation, performed by the DRM 8, is represented by step 56 in FIG. 4.

If the payment amount is less or equal to the value of the voucher, then the DRM engine 8 authorises a payment. In authorising the payment, the DRM engine generates a new voucher based on the payment contract information (a voucher for an exact number of credits), decreases the voucher value stored in the secure memory 30 optionally signs the voucher digitally, and sends it to the payment application. This is represented by step 58 in FIG. 4. A revised voucher value is then available for comparison in future purchases. The payment application transmits the voucher further to the vending machine, as illustrated by step 60. In alternative embodiments of the invention, the DRM engine may not create a new voucher. Instead, the DRM engine 8 may send to the point of sale a copy of the original voucher, a version of the voucher modified differently to that outlined above or alternatively may send information from the voucher to the point of sale. The information may include account information, information approving the purchase or the like.

If, however, the payment amount is greater than the remaining value of the stored voucher, then the payment is not authorised by the DRM engine. Thus, the DRM engine 8, prevents payment if the mobile device does not have sufficient pre-paid credit in the voucher store 30.

FIG. 4 In one embodiment, the voucher provided to the mobile device is a simple voucher corresponding to a certain amount of money. Such a voucher is preferably provided to the user 2 by the bank 6 based on a secure financial relationship between the user and the bank. In an alternative, the voucher provided to the mobile device may represent a more sophisticated means of performing a financial transaction. In one embodiment it is proposed that the voucher comprises an electronic cheque book.

Such an electronic cheque book may actually comprise a certificate, which acts as a template for an e-cheque. The payment application then fills the appropriate fields of the e-cheque when forwarding the voucher to the point-of-sale terminal in step 60 of FIG. 4. The details added to the e-cheque may include: the e-cheque serial number, the date, the payee, an invoice number and the payment amount. In the same manner as described hereinabove with relation to a simple voucher scheme, the DRM engine also ensures that the payment amount does not exceed a credit limit on the electronic cheque book account. Thus, in this embodiment, the voucher comprises an electronic cheque book which is associated with an account limit. The e-cheque sent to the point-of-sale terminal is digitally signed using known techniques.

Thus, in accordance with the present invention, the amount spent by a mobile device is limited by a credit limit acquired from the bank, or other service provider, and stored under the control of the DRM engine. As such, a user cannot spend in excess of a credit amount which has been provided by their own service provider. As such, a method of off-line credit guarantee is provided.

One further advantage of the present invention is that it particularly provides a convenient method of making micro-payments.

The point-of-sale terminal checks off-line, or on-line, the validity of the voucher or e-cheque using, for example existing digital signature techniques.

In the above, a technique for electronic payments using pre-paid coupons or vouchers has been described. The present invention applies equally advantageously to ‘post-paid’ coupons or vouchers. With post-paid coupons, the credit limit applies to a limit for maximum payment. That is, the limit prevents a transaction exceeding a certain amount of money. In such a scenario, the limit stored in the secure memory is not decreased as purchases are made, and all payments are charged later in a credit-card fashion.

Thus a user of a DRM enabled mobile device can download pre-paid coupons to the terminal, and can purchase goods or services but cannot exceed the value of the coupons. The vouchers are therefore effectively used as electronic money. The use of digital signatures, or any other known authentication method, and the DRM functionality of the mobile device ensures a very secure model.

The implementation of the present invention may require point-of-sale terminals to be modified to incorporate the necessary short range wireless link to the mobile device. Software updates may also be required in order to validate the vouchers and digital signatures provided by the mobile device. In addition, it may be necessary for the point-of-sale terminals to carry out a secure handshake with the DRM engine of the mobile device, to ensure that the mobile device is DRM enabled, as it is the DRM enablement of the mobile device which provides the guaranteed credit of the operation.

Although the present invention has been described with reference to particular embodiments, a person skilled in the art will appreciate that the invention is more generally applicable, and is only limited by the scope of the appended claims.

1. A method for facilitating payments in a digital rights management enabled mobile device, comprising providing the mobile devicewith a payment voucher having a value limit.

2. A method according to claim 1 wherein the voucher is provided by any one of: a credit agency; a bank; or a service provider.

3. A method according to claim 1 or claim 2 further comprising transmitting a payment from the mobile device using the payment voucher.

4. A method according to claim 3 wherein the payment is transmitted responsive to a request for payment.

5. A method according to claim 4 wherein responsive to request for payment, a payment amount is compared to the payment voucher amount remaining.

6. A method according to claim 5, wherein the step of transmitting a payment is enabled responsive to the payment amount being less than or equal to the payment voucher remaining.

7. A method according to claim 6, wherein responsive to the step of transmitting a payment, the amount of the payment voucher is decreased by the payment amount.

8. A method according to any one of claims 3 to 7 wherein the step of transmitting a payment includes a step of transmitting a digital signature.

9. A method according to any preceding claim, wherein the voucher comprises an electronic cheque book.

10. A method according to any one of claims 1 to 9 wherein the payments are digital signature based.

11. A method as claimed in any preceding claim, wherein said value limit is a credit limit.

12. A digital rights management enabled mobile device comprising means for receiving a payment voucher having a value limit for use in payments.

13. A mobile device according to claim 12 further comprising means for transmitting a payment using the payment voucher.

14. A mobile device according to claims 12 or 13 wherein the means for transmitting a payment is enabled by the digital rights management engine.

15. A mobile device according to claim 14 wherein the digital rights management engine is adapted to control the means for transmitting a payment responsive to receipt of a payment request.

16. A mobile device according to claim 15 wherein there is further provided receiver means for receiving the payment request.

17. A mobile device according to claim 16 wherein the means for receiving the payment request is a local receiver.

18. A mobile device according to any one of claims 15 to 17 wherein the digital rights management engine is adapted to compare a payment amount in the payment request with the payment voucher amount.

19. A mobile device according to claim 18 wherein the digital rights management engine enables the means for transmitting a payment if the payment amount is less than or equal to the payment voucher amount.

20. A mobile device according to any one of claims 14 to 19 wherein responsive to the transmission of a payment the digital rights management engine reduces the amount of the payment voucher by the payment amount.

21. A mobile device according to any one of claims 12 to 20 wherein the mobile device is a mobile telephone.

22. A mobile device according to any one of claims 12 to 21 wherein the payments are digital signature based

23. A mobile device as claimed in any of claims 12 to 22, wherein said value limit is a credit limit.
